(19) United States
(12) Patent Application Publication
(10) Pub. No.: US 2007/0108232 A1
(43) Pub. Date: May 17, 2007

(54) WATER BOTTLE

(76) Inventor: Dan Loebach, Bala (CA)

Correspondence Address: MARK A KOCH, 866 MAIN STREET EAST, HAMILTON, ON, L8M1L9, CA

(21) Appl. No.: 11/550,017

(22) Filed: Oct. 17, 2006

Related U.S. Application Data
(60) Provisional application No. 60/597,086, filed on Nov. 9, 2005.

(51) Int. Cl. B67D 5/60

(52) U.S. Cl. 222/143

(57) ABSTRACT

A water bottle comprising a top surface, a bottom surface and generally cylindrical walls jointing together top and bottom surfaces; further including a neck projecting upwardly from the top surface and a bottom cavity defined in the bottom surface, for receiving the neck therein of a bottle below when the bottles are stacked one on top of the other.

The application claims priority from previously filed U.S. provisional patent application No: 60/597,086, titled “WATER BOTTLE” on Nov. 9, 2005 by Dan Loebach.

### FIELD OF THE INVENTION

The present invention relates to water containers and in particular relates to plastic blow moulded water bottles.

### BRIEF DESCRIPTION OF THE DRAWINGS

The invention will now be described by way of example only with reference to the following drawings in which:

FIG. 1 is a top perspective view of the present invention a water bottle.

FIG. 2 is a front side elevational view of the present invention a water bottle.

FIG. 3 is a rear side elevational view of the present invention a water bottle.

FIG. 4 is a top plan view of the present invention a water bottle.

FIG. 5 is a bottom plan view of the present invention a water bottle.

FIG. 6 is a top perspective view of an alternate embodiment of the present invention a water bottle.

FIG. 7 is a partial side elevational view of the alternate embodiment shown in FIG. 6.

FIG. 8 is a top elevational view of the alternate embodiment shown in FIG. 6.

FIG. 9 is a side plan view of the alternate embodiment shown in FIG. 6.

FIG. 10 is a bottom perspective view of the alternate embodiment shown in FIG. 6.

FIG. 11 is a side partial cut away plan view of two alternate embodiments of the water bottle shown one stacked on top of the other together with the pre-form shown in the top bottle.

### DETAILED DESCRIPTION OF THE PREFERRED EMBODIMENT

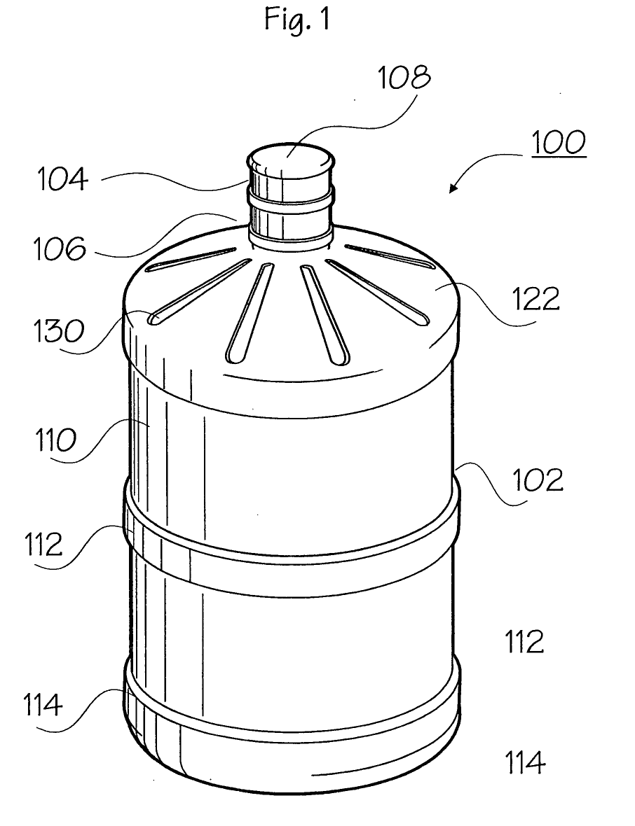

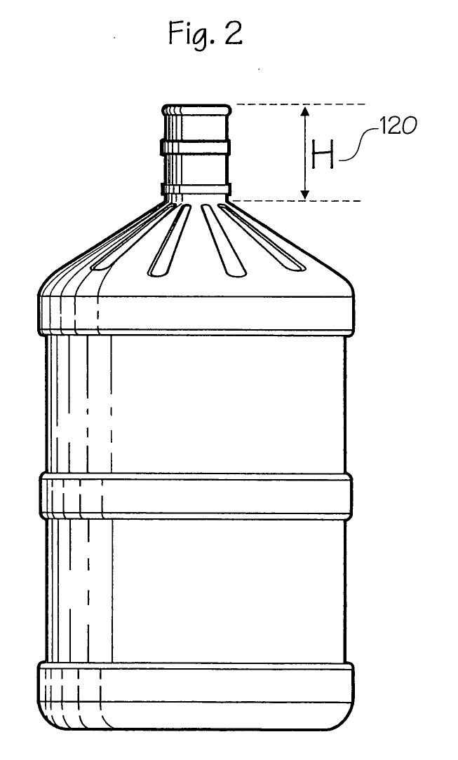

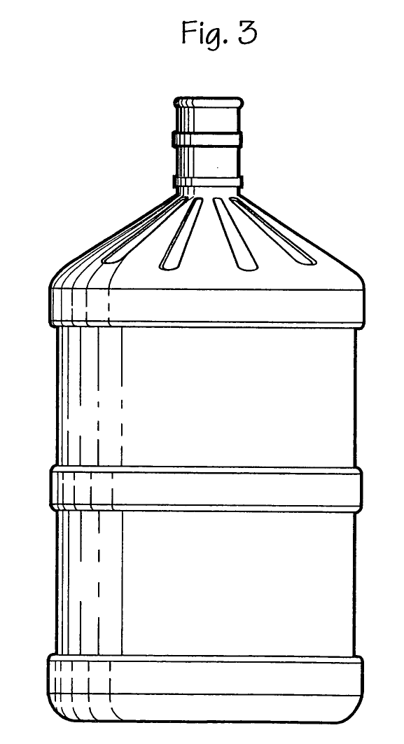

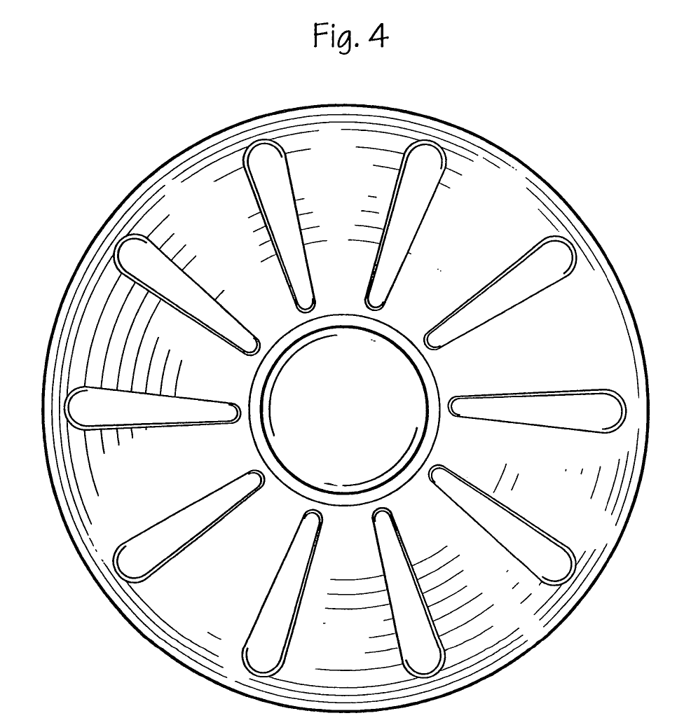

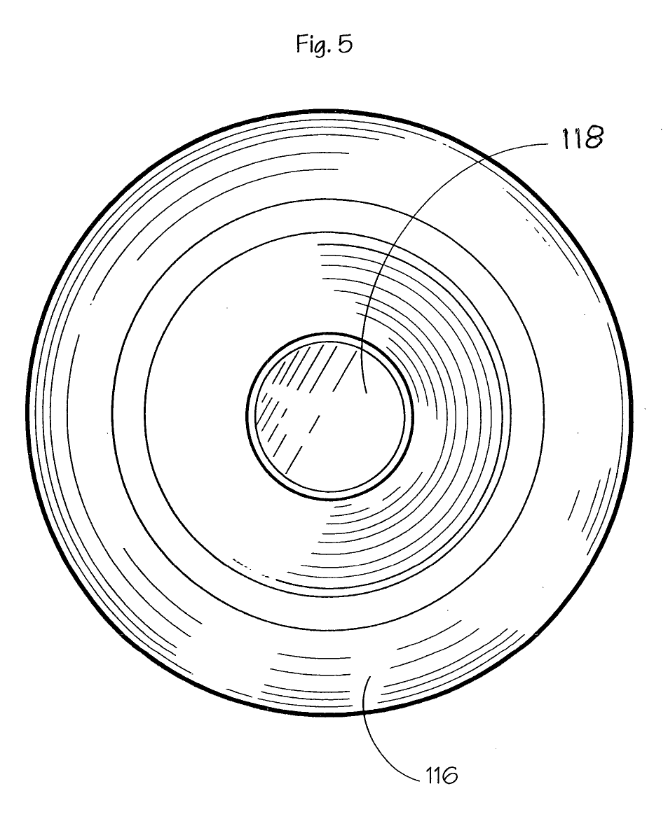

The present invention a water bottle shown generally as 100 in FIGS. 1 through 5.

Water bottle 100 includes the following major components, namely body 102, spout 104, neck 106, cap 108, top reinforcing rib 110, middle reinforcing rib 112, bottom reinforcing rib 114, bottom 116 having a bottom cavity 118, and a spout height designated as H shown as 120.

This plastic water bottle 100 is preferably made out of P.E.T. Plastic, which is blow moulded with conventional methods known in the art. The top portion 122 of water bottle 100 includes an elongated neck 106, having a spout 104 and prior to use is capped off with cap 108. The bottom 116 of water bottle 100, includes a bottom cavity 118 which is dimensioned to accept spout 104 therein, such that when one water bottle 100 is stacked upon another water bottle 100, the bottom 116 of water bottle 100 rests upon shoulder 130 of water bottle 100 as shown in the figures.

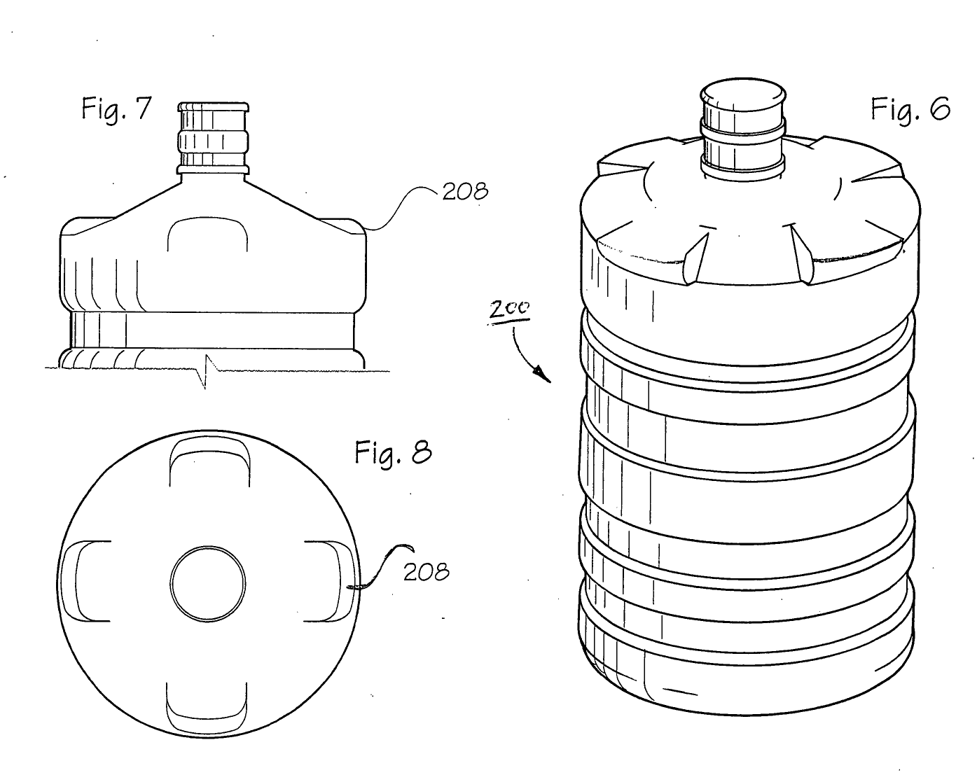

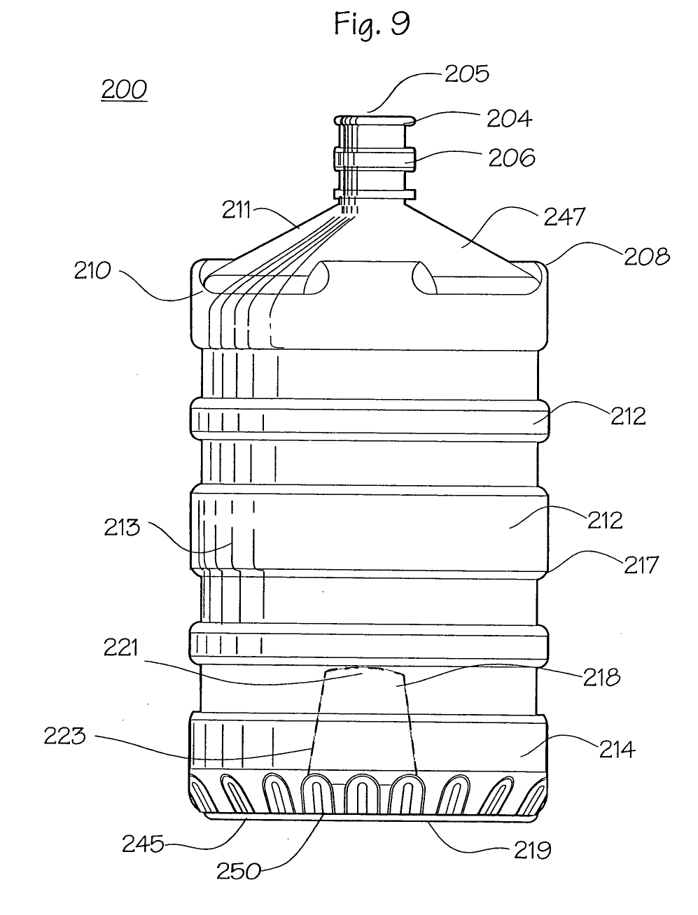

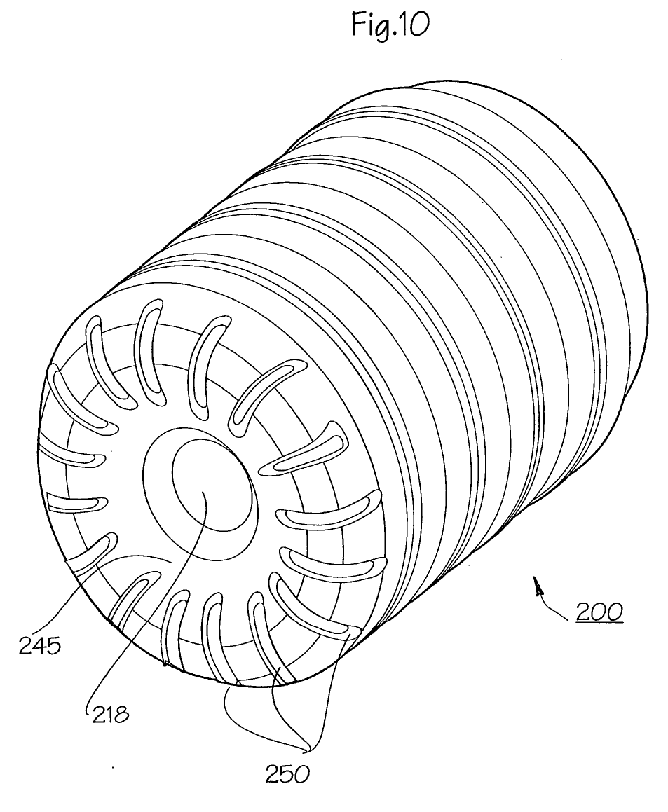

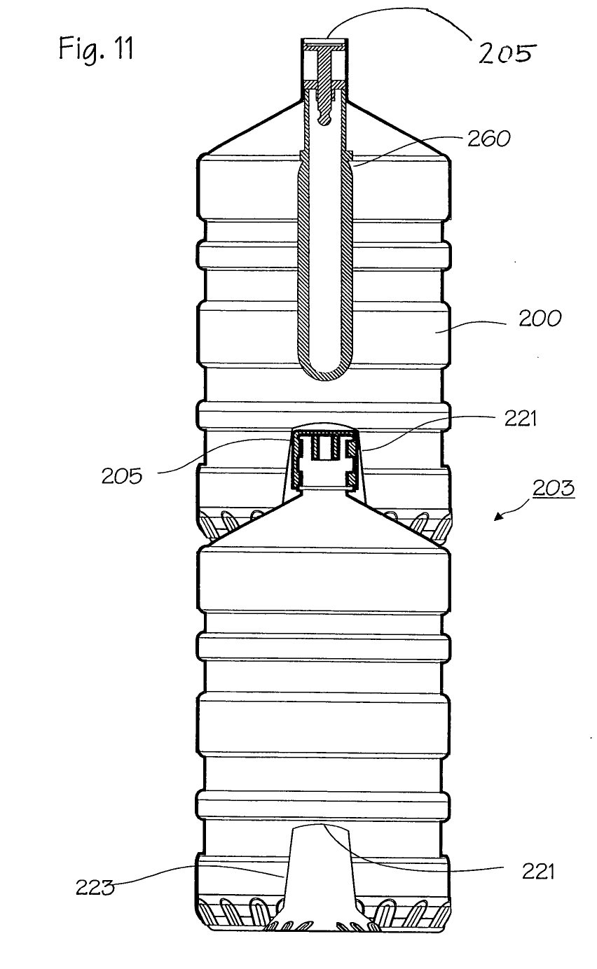

An alternate embodiment of the present invention is shown as water bottle 200 in FIGS. 6 through 11.

Water bottle 200 includes the following major components, namely body 213 including a top 211 having a spout 204 projecting upwardly there from. Spout 204 includes a spout top surface 205. Body 213 also includes a bottom 245 including a bottom surface 219 and a bottom cavity 218 for receiving a spout therein when the water bottle 200 is in a stacked position 203 with another water bottle 200 as shown in FIG. 13. Spout 204 includes a neck portion 206. Body 213 includes top surfaces 247 shoulders 208, top reinforcing rib 210, middle reinforcing rid 212, bottom reinforcing rib 214, bottom cavity 218 and bottom reinforcing grooves 250. Bottom cavity 218 includes a cavity top surface 221 and cavity side walls 223. The bottom reinforcing grooves 250 extending at least partially radially outwardly toward the outside diameter 217 of water bottle 200 to reinforce the bottom 245 of water bottle 200.

In the stacked position as shown in FIG. 11 the upper or stacked water bottle is supported when bottom surface 219 of the upper water bottle 200 makes contact with top surfaces 247 of the lower water bottle 200. In the stacked position as shown in FIG. 11 the upper or stacked water bottle is also supported when cavity top surface 221 of the upper water bottle 200 makes contact with spout top surface 205 of the lower water bottle 200. In this manner the weight is distributed onto the top surfaces 247 of lower water bottle proximate outside diameter 217 and also onto spout 204. In this manner multiple contacts between the upper and lower bottle are created.

In one embodiment the bottom surface 219 of the upper water bottle 200 makes contact with shoulders 208 of the lower water bottle 200.

FIG. 11 shows two water bottles 200 stacked one on top of each other in a stacked position 203. In addition, the top water bottle shows a mould pre-form 260 which are used to blow mould water bottle 200. In order to be able to stack water bottles 200, one on top of each other without crushing the bottle on the bottom, a number of reinforcing ribs circumferentially around the outside diameter 217 including top reinforcing rib 210, middle reinforcing rib 212 and bottom reinforcing rib 214. The number and frequency of the positioning of these ribs can be altered in order to change the strength performance of the water bottle. Note that neck 206 of spout 204 is nested inside of bottom cavity 218 of the bottle just above. This feature makes it possible to put two or more bottles into stacked position 203. The bottom surface 245 includes bottom reinforcing grooves 250 to help distribute the load along bottom surface 245. Shoulder 208 is incorporated in top surface 247 in order to ensure that the load is transmitted down the side walls 249 of water bottle 200. By incorporating shoulders 208, the water bottle 200 can bear a greater amount of stackable weight and thereby make it feasible to stack one water bottle on top of another without crushing the bottle below.

It should be apparent to persons skilled in the arts that various modifications and adaptation of this structure described above are possible without departure from the spirit of the invention the scope of which defined in the appended claim.

I claim:

1. A nestable water bottle comprising;
a) a body including a top and a bottom,
b) the body including a spout projecting upwardly from the top;
c) the body including a bottom cavity dimensioned to receive the spout therein when one water bottle bottom is positioned onto another water bottle top in a stacked position.

2. The water bottle claimed in claim 1 wherein the body further including a top surface and bottom surface wherein the top surface making contact with the bottom surface when two or more water bottles are in a stacked position.

3. The water bottle claimed in claim 1 wherein the bottom cavity further including a cavity top surface and spout including a spout top surface wherein the cavity top surface making contact with the spout top surface when two or more water bottles are in a stacked position.

4. The water bottle claimed in claim 1 wherein the body further including a top surface and bottom surface wherein the top surface making contact with the bottom surface when two or more water bottles are in a stacked position and wherein the bottom cavity further including a cavity top surface and spout including a spout top surface wherein the cavity top surface also making contact with the spout top surface when two or more water bottles are in a stacked position.

5. The water bottle claimed in claim 1 wherein the body further including shoulders wherein the shoulders making contact with the bottom surface when two or more water bottles are in a stacked position.

6. The water bottle claimed in claim 1 wherein the body further including at least one reinforcing rib extending circumferentially around the outside diameter of the water bottle.

7. The water bottle claimed in claim 1 wherein the body further including bottom reinforcing grooves extending at least partially radially outwardly toward the outside diameter of the water bottle to reinforce the bottom of the bottle.

8. A system of stacking one water bottle on top of another, the system including:
a) a water bottle including a body including a top and a bottom,
b) the body including a spout projecting upwardly from the top;
c) the body including a bottom cavity dimensioned to receive the spout therein when one water bottle bottom is positioned onto another water bottle top in a stacked position.

9. The system claimed in claim 8 wherein the body further including a top surface and bottom surface wherein the top surface making contact with the bottom surface when two or more water bottles are in a stacked position.

10. The system claimed in claim 8 wherein the bottom cavity further including a cavity top surface and spout including a spout top surface wherein the cavity top surface making contact with the spout top surface when two or more water bottles are in a stacked position.

11. The system claimed in claim 8 wherein the body further including a top surface and bottom surface wherein the top surface making contact with the bottom surface when two or more water bottles are in a stacked position and wherein the bottom cavity further including a cavity top surface and spout including a spout top surface wherein the cavity top surface also making contact with the spout top surface when two or more water bottles are in a stacked position.

12. A nestable water bottle comprising a top surface, a bottom surface and generally cylindrical walls jointing together top and bottom surfaces; further including a spout projecting upwardly from the top surface and a bottom cavity defined in the bottom surface, for receiving the neck therein of a bottle below when the bottles are stacked one on top of the other.
